(19) United States
(12) Patent Application Publication
(10) Pub. No.: US 2022/0024786 A1
(43) Pub. Date: Jan. 27, 2022

(54) GAS-DRIVEN DIFFUSIOPHORETIC WATER FILTRATION DEVICE WITH IMPROVED INLET, OUTLET AND MEMBRANE STRUCTURES TOOL

(71) Applicant: Split Rock Filter Systems LLC, New Paltz, NY (US)

(72) Inventor: William C. Gehris, New Paltz, NY (US)

(21) Appl. No.: 17/298,569

(22) PCT Filed: Dec. 12, 2019
(86) PCT No.: PCT/US2019/065976

§ 371 Date: May 29, 2021

Related U.S. Application Data
(60) Provisional application No. 62/778,847, filed on Dec. 12, 2018.
(60) Provisional application No. 62/780,910, filed on Dec. 17, 2018.
(60) Provisional application No. 62/783,168, filed on Dec. 20, 2018.
(60) Provisional application No. 62/784,310, filed on Dec. 21, 2018.
(60) Provisional application No. 62/783,366, filed on Dec. 21, 2018.
(60) Provisional application No. 62/784,511, filed on Dec. 23, 2018.
(60) Provisional application No. 62/784,728, filed on Dec. 25, 2018.
(60) Provisional application No. 62/786,399, filed on Dec. 29, 2018.

(51) Int. Cl. C02F 1/469; C02F 1/00; C02F 1/44

(52) U.S. Cl. CPC C02F 1/4696; C02F 1/006; C02F 1/44; C02F 2301/022; C02F 2201/002; C02F 2301/04; C02F 1/001

(57) ABSTRACT

A diffusiophoretic water filter has improved inlet, outlet and membrane structures. A support is also disclosed as are method for manufacturing and assembling the diffusiophoretic water filter.

This claims the benefit of U.S. Provisional Application Nos. 62/778,847, filed Dec. 12, 2018, 62/780,910, filed Dec. 17, 2018, 62/783,168, filed on Dec. 20, 2018, 62/784,728, filed on Dec. 25, 2018, 62/783,366, filed Dec. 21, 2018, 62/784,310, filed Dec. 21, 2018, 62/784,511, filed on Dec. 23, 2018 and 62/786,399, filed Dec. 29, 2018. All of the above listed patent applications are hereby incorporated by reference herein.

### BACKGROUND

WO 2018/048735 discloses a device operative in separating particles in a flowing suspension of the particles in a liquid which device comprises: a first, pressurized cavity or plenum adapted to contain a gas, separated by a first gas permeable wall from a second cavity or plenum which contains a charged particle containing liquid which also contains an ion species formed by the dissolution of the gas within the liquid, which is in turn separated by a second permeable wall from the ambient atmosphere or an optional, third, relatively reduced pressure cavity or plenum which may contain a gas or a vacuum; wherein: the permeable walls operate to permit for the transfer of a gas from the first cavity through the second cavity and through the second permeable wall to the atmosphere or a third cavity and, the pressure present in atmosphere or the third cavity is lesser than that of the first cavity, thus forming an ion concentration differential within the liquid and between the permeable walls.

The related article “Membraneless water filtration using CO2” by Shin et al. (Nature Communications 8:15181), 2 May 2017, describes a continuous flow particle filtration device in which a colloidal suspension flows through a straight channel in a gas permeable material made of polydimethylsiloxane (PDMS). A CO2 (carbon dioxide) gas channel passes parallel to the wall and dissolves into the flow stream. An air channel on the other side of the wall prevents saturation of CO2 in the suspension and the resulting gradient of CO2 causes particles to concentrate on sides of the channel, with negatively charged particles moving toward the air channel and positively charged particles toward the CO2 channel. The water away from the sides of the channel can be collected as filtered water.

The article “Diffusiophoresis at the macroscale” by Mauger et al. (arXiv: 1512.05005v4), 6 Jul. 2016, discloses that solute concentration gradients caused by salts such as LiCl impact colloidal transport at lengthscales ranging roughly from the centimeter down to the smallest scales resolved by the article. Colloids of a diameter of 200 nm were examined.

The article “Origins of concentration gradients for diffusiophoresis” by Velegol et al, (10.1039/c6sm00052e), 13 May 2016, describes diffusiophoresis possibly occurring in georeservoir extractions, physiological systems, drying operations, laboratory and industrial separations, crystallization operations, membrane processes, and many other situations, often without being recognized.

PCT Publication WO 2015/077674 discloses a process that places a microparticle including a salt in proximity to a membrane such that the microparticle creates a gradient generated spontaneous electric field or a gradient generated spontaneous chemiphoretic field in the solvent proximal to the membrane. This gradient actively draws charged particles, via diffusiophoresis, away from the membrane thereby removing charged particulate matter away from the membrane or preventing its deposition.

### SUMMARY OF THE INVENTION

U.S. Pat. No. 10,463,994 and PCT Publication No. WO 2019/099586 of the present applicant describe diffusiophoretic water filtration devices and both are incorporated in their entirety herein.

For gas-driven diffusiophoretic water filters, one of the most difficult challenges has been simplifying the inlet and outlet structures, as well as the filter structure to provide for easily scalable and cost-effective diffusiophoretic water filtration.

The present applicant has developed a gas-driven diffusiophoretic water filter (DWF) that addressed almost all the of the problems faced until now, and simplifies the inlet and outlet structures and manufacturing difficulties found in the devices described in WO 2018/048735.

The present invention advantageously provides an easily manufactured and assembled, cost-effective and scalable diffusiophoretic water filtration system that is less prone to clogging and easier to operate than prior art devices.

The present invention first provides for a simplified inlet structure that allows placement of the DWF directly in a reservoir or with another type of simple manifold structure, such as a tube with a longitudinal slit.

The present invention thus provides a diffusiophoretic water filter with a membrane having a first side and an opposing second side, at least one membrane having a plurality of diffusiophoretic water channels in the first side between a first free end and a second free end of the membrane, the diffusiophoretic water channels having inlets at the first free end.

By having the inlets at a free end of the membrane, the free end can be placed in a reservoir or covered by a tube without regard to placement of the membrane or the size of the reservoir or tube, and allows for easy sealing of the inlet and setting of flow velocity for example by a water height or pressure in an easy manner.

The first free end preferably has a first edge that is perpendicular to the first side, the inlets being cut into the free end at the first edge.

The at least membrane preferably includes two membranes sandwiched together to define the channels, and most preferably the two membranes are of similar structure facing each other so that each of the membranes defines half of a height of the channel.

This construction then allows for easier implementation of a second key aspect of the present invention, which is a simplified outlet structure.

The present invention also provides a DWF with a membrane having a first side and an opposing second side, at least one membrane having a plurality of diffusiophoretic water channels in the first side between a first free end and a second free end of the membrane, the diffusiophoretic water channels having an outlet at the second free end. An outlet splitter extends into the second free end and contacts the at least one membrane to split the diffusiophoretic water channels into a clean water stream and a waste water stream.

By having a separate outlet splitter extend into the second free end, the at least one membrane may be manufactured separately and easily and cost-effectively, and also the clean water may be collected more effectively from the second free end and waste water discarded or reused more effectively.

The second free end preferably has a second edge that is perpendicular to the first side, the inlets being cut into the second free end at the second edge.

The at least membrane preferably includes two membranes sandwiched together to define the channels, and most preferably the two membranes are of similar structure facing each other so that each of the membranes defines half of a height of the channel.

The use of membranes with a plurality of diffusiophoretic water channels in the first side between a first free end and a second free end of the membrane also allows for advantageous methods of manufacture and low-cost devices.

In a first method, a roll of gas-permeable material such as PDMS can be unrolled from a roll, and moved in a longitudinal direction, the channels at least partly manufactured into the material by a plurality of lasers extending transverse to the longitudinal direction. The material can then be cut transversely to form the membrane.

The lasers preferably are stationary.

Advantageously, in one embodiment the membrane has a half channel with a half thickness so that the membranes can be sandwiched together around a splitter to form a 50/50 split. However, other than 50/50 splits are possible if one membrane has for example 70% of a channel thickness and another membrane has 30% of the thickness.

In a second embodiment the channels are manufactured at full thickness on one membrane and an unstructured or flat membrane can top the membrane with the channels. In this embodiment the splitter is not sandwiched between two membranes but can be stuck into the second edge of the structured membrane, for example as a steel blade entering a PDMS material, or manufactured by at least one laser into the second edge of the structured membrane.

The edge laser preferably is more precise and of higher quality, such as an Nd:YAG laser than the channel lasers, which may be for example inexpensive CO2 lasers, to permit thin splitters.

In the first method, the structured membrane can be re-rolled and then cut to length as desired, a length of the cut material defining length of the channels in a DWF. The width of the roll can define the width of the DWF.

In a second method, the roll of gas-permeable material is unrolled from a roll and moved in longitudinal direction, preferably stopped, and then an array of channel lasers extending in the longitudinal direction is moved transverse to the longitudinal direction. The array of channel lasers can extend for several meters or tens of meters or more and includes thousands or tens of thousands or more of inexpensive lasers for manufacturing the channels. The material can then be rolled up again and transported easily. Kilometers of inexpensive gas-permeable material can be inexpensively manufactured, and cut to length when desired, the cut length then defining the width of the membrane in a DWF.

Preferably, the width of the roll in the second method is the same as a desired length of the channels, for example between 30 cm and a meter, and each edge of the roll defines the first and second ends of the membranes. In this way the roll need not be split longitudinally. The width thus defines the dwell time of water in the channels.

In either the first or the second method, the gas permeable material may advantageously have a first flat side into which the channels are manufactured, and a second ribbed side, for example with 1 mm spaced ribs transverse to the unrolling direction. The ribs can be made by lasers or during manufacture of the membrane. The channels preferably are manufactured on the flat side opposite the space between the ribs. In this way, the channels are on narrower membrane material, and the spacing between the ribs can permit both CO2 or other gas to reach the channels, and also allow the opposite side of the channels to face atmosphere or another area with a lower concentration than the gas creating diffusiophoretic action.

The ribs also advantageously can be used to keep the membrane taut at the channels and also to permit the membrane to be supported by a support, preferably of a more rigid material.

In one embodiment, the present invention thus provides a gas-driven diffusiophoretic filter with a first membrane support having a longitudinally-extending first hollow interior; a gas-permeable first membrane covering the first hollow interior. A second membrane support can support a gas-permeable second membrane, the first and second supports being positionable so that the first and second membrane define at least one diffusiophoretic water channel.

Advantageous further optional features of the invention include one or more of the following, alone or in combination:

the first and/or second membranes have two longitudinally-extending side walls between a channel base, for example each having a 120 micrometer thick PDMS side wall approximately 0.5 cm wide, with a membrane base having a thickness of 30 micrometers extending 1.5 cm widthwide between the side walls;

longitudinally extending support ridges extend from the membrane base to match the side wall thickness and aid in preventing bulging, this the 1.5 cm wide channel may for example have two ridges each 0.3 cm wide and extending out 120 micrometers evenly spaced so that three 0.3 cm wide longitudinal flow half-channels are defined. Many more ridges and narrower channels, as well as thinner or thicker half-channels can be provided, with a thickness of a total channel preferably being less than 1 mm and thus of a half channel being 500 micrometers;

the side walls and membrane base are manufactured together, preferably by soft lithography of a PDMS or other gas-permeable material. The simple channel structure allows for inexpensive and simple lithography masks, for example of a membrane with a one to ten half-channels 120 micrometers thick into a 150 micrometer thick PDMS material;

the first and second membranes are identical, so that the side walls and any ridges align when contacted together so that the two half-channels define a full channel, advantageously easing manufacture, so that a single mask for example can be used to create a channel structure;

in an alternate embodiment the first and second membranes are simply sheets of unstructured gas-permeable material, such as PDMS 30 micrometers thick, and a separate channel structure made for example of tapes is laid over the membranes;

the first and second support structures are identical, and made of plastic, most preferably PVC and have a length between 30 and 170 cm, more preferably between 50 and 150 cm, and most preferably between 60 and 120 cm, which allows for excellent handling and easy assembling of the filter by hand, as will be described, while still allow for long dwell timed for diffusiophoretic action. In a preferred embodiment the first and second support structures are 80 cm in length;

the first and second supports each have a U-shaped cross-sectional wall structure with top edges of the wall structure being a similar width, within 25%, more preferably 10% and most preferably the same, as the membrane side wall width. This provides excellent support for the membrane on the support. The walls of the support structures thus may be 50 mm wide for example, extending from a 2.5 cm side base, so that the hollow interior is 1.5 cm wide. Inwardly bent top edges can be provided for a larger support surface and use of thinner walls for the supports;

the height of the hollow interior varies, with a 2 cm height being provided in one embodiment so that the outer sidewalls and base wall all have a same length for a square cross-sectional shape. However, a higher height of the side walls may be preferable to ensure proper assembly in a ground support and avoid any confusion or improper placement into slots in the ground support;

the first and second membranes are glued or adhered, for example with a silicone-based adhesive, to the top edges of the walls of the support structures, with the membrane preferably being stretched taut widthwise and/or lengthwise, although the membrane can simple be laid on the adhesive as well without widthwise or lengthwise stretching. The gluing or adhering provides a simple manufacturing method;

the first and second supports have closed first inlet ends. This advantageously allows the inlet of the channels to be sealed by an inlet manifold extending over the supports;

the first membrane extends over the first end of the first support, which allows longitudinal stretching of the membrane and a tauter longitudinal fit of the first membrane. Previous designs had permitted widthwise tautness that sometimes resulted in ridges extending widthwise during attachment of the membrane to the support structure. The first membrane can alternately or additionally extend over the outlet end of the first support; and alternately or additionally the second membrane can be similarly attached to the second support;

an inlet manifold surrounds and seals both the first and second membrane support structures, the inlet ends of the support structures being water-tight so water to be filtered presses against the inlet ends but does not enter the support structures and only enters the inlet. This structures advantageously greatly simplifies sealing of the inlet, and the fact that unfiltered water rests against the support structures surprisingly has no effect on the operation of the device and actually the inlet manifold can aid in sealing the first and second membrane supports toward each other to, for example, increase sealing by the channel structure between the first and second membranes;

the inlet manifold can be heat shrunk, for example by polythene tube, or can include an elastic tube that is stretched over the first and second ends of the first and second support structures. The other end of the manifold can be easily attached to a height regulator, for example a plastic tube that can be used to set the inlet pressure;

the inlet manifold can supply a plurality of modular water filters defined by a first and second support with the first and second membranes, supported widthwise for example in a ground support;

the first and second supports can support both the first and second membranes and a channel structure, either integral with the membranes as described above, for example side tapes or structuring on the membranes, and thus define first and second mating components of the filter. Preferably the structures can be identical on both the first and second mating components, and an outlet splitter then placed between the first and second components at the outlet to create a simply created and efficient outlet structure. For example copper foil of 30 micrometer thickness can be used to create a waste water outlet, and simply wrapped around the second outlet structure to create an outlet channel;

the outlet splitter can be a separate tube for example with a hollow U-shaped PVC or other plastic support having a hollow U-shaped interior matching the exterior dimensions of one or both of the first and second supports and a side wall of the membrane. The dimensions of the splitter support tube hollow interior thus could be 2.5 cm wide and 2.5 cm, and the splitter support walls can be 0.5 cm thick. A steel blade, with a 5 to 15 micrometer thick edge and becoming thicker, for example 100 micrometers thick, can be adhered over the longitudinally extending opening of the splitter support tube, for example with two sided adhesive tape having a thickness similar to the side walls of the membrane, for example 125 micrometers thick. The splitter support also could be made of elastic materials such as rubber, with the steel blade supported therein, as the steel blade positioning is aided by the side walls and sandwiched at the proper position between the two membrane side walls and any ridges;

the walls of the U-shaped splitter support can be closed by a cross wall downstream of the steel blade to reduce metal cost, and to allow a support for the steel blade and a base for waste water to flow over;

the outlet splitter can be manufactured entirely from plastic, for example having a PVC 30 micrometer thick edge at the splitter side, the outlet splitter preferable then having a hollow interior with a thickness equal to an outer thickness of the support added to a side wall thickness, for example 2.5125 cm. The splitter can have 0.5 cm walls that narrow or taper, preferably on a side facing the clean filtered water down to 30 micrometers or less between the membranes;

the splitter supports at a downstream end can connect to a perpendicular waste water collector, for example via a closed flexible tube with openings attaching to the ends of the splitter supports. This structure is advantageous if harmful particles such as PFOAS or PFOS are being filtered, and allows for sealed capture of the waste water. However, gravity and a simple sloped perpendicular open gutter could be used to capture the waste water;

the first and second mating components advantageously can be designed to be identical and modular. Each can support the respective membrane on one side and be either gas tight to permit for example carbon dioxide pressures of 1.3 atm and up to for example 2 atm or more, or openable to permit air to enter. More than one set of first and second components can sit side by side and be connected together by a larger inlet manifold, and share a single outlet splitter (or having individual ones), so that for example a diffusiophoretic water filtration device a whole field a meter or more wide can be created, and large scale municipal water filtration devices operated;

each modular pair of mating components can be monitored for proper flow and easily and inexpensively replaced. For example a flow or water presence sensor can be placed at each outlet splitter support, preferably monitoring the waste water stream. If a defect is ascertained, the device stopped and the components can be easily replaced, simply by sliding in a new modular pair or one of the defective supports;

a ground support can be used to permit multiple sets of mating components to slide into the ground support, and allow easy construction of large scale filter. The support can be shorter than the membrane supports to allow the outlet splitter space to fit between module pairs. The support could also be shorter at the inlet side, and allow for a rubber seal or extra sealing at the inlet;

the first and second membrane supports each have at least one hole or longitudinally extending slot to permit air to enter the support. The slot can be sealed by a mating rubber or other seal, for example at the bottom support surface of the ground support, so that the bottom support is sealed to define a gas delivery component of the mating components. The top support can remain open to atmosphere due to the hole or slot. The slot of the gas delivery membrane support also can simply be closed with duct tape, preferably inside the membrane support, or closed simply using the bottom of the ground support, even if the seal is not perfect;

the outlet end of the first and second supports opposite the sealed inlet first end can be open, or preferably be a closed end with a hole for a gas attachment;

a gas delivery tube can attach to the hole of the gas delivery component of the mating components to define a gas inlet while the hole of the other mating component can remain open to atmosphere. If open, the entire end can for example be sealed with a rubber stopper having a hole connecting to a gas delivery tube.

a perpendicular running gas delivery tube can deliver a gas such as CO2 to a plurality, even hundreds or more, of side-by-side gas delivery components, with the tube having side tubes connecting to the gas inlets;

the ground support has a plurality of side-by-side longitudinally extending slots into which a pair of the first and second mating components fit, preferably tightly. An interior width of the slot preferably thus is matched to an exterior width of the first and second mating components and most preferably to a width of the first and second supports. Any membrane width, if present, extending over the outside of the support can discounted and the support walls can aid in sealing the membrane. The ground support thus may for example be made of PVC and have a wall width of 1 cm throughout, with legs supporting the structure off the ground. If the supports are 80 cm long, in one embodiment, the ground support is 60 cm long, sits on 4 10 cm square legs and has widthwise 20 slots each 2.5 cm wide with 19 1 cm wide walls in between and 1 cm wide end sides for a total width of 61 cm. The slots in this embodiment are 5 cm high to support the first and second supports, which are 2.5 cm high and spaced by the side walls. Any small extension of the mating component pair out of the slot is advantageous, as it pressing on the extension, for example by a weight, can aid in sealing the side walls together and thus sealing the diffusiophoretic flow channels;

if only one mating pair is used, the ground support can have a single slot;

the outside walls of the components pairs and the ground support side walls preferably are flush, so that the only opening on the front end of the structure are the diffusiophoretic flow channels. Additional seals or sealants can be used to prevent leakage, although minor leakage, for example at the sides of end walls, advantageously can be tolerated, and perfect sealing is advantageously not required. The entire filtration device can sit on a collection surface so that any dripping water can be collected and if desired returned to the water source to be filtered;

the water pressures used, typically on the order of 30 to 70 mbar, advantageously are not so high as to create large pressures as slow flows are desired to permit laminar flow and aid diffusiophoretic action by increasing dwell time in the channels, and can be set for example by having the water to be filtered remain around a setpoint height of chosen from a height of about 30 to 70 cm above the outlet(s);

the inlet manifold advantageously can then surround the entire inlet face of the support structure, which at the front end sites off the ground, as the legs can be recessed downstream;

a top plate can be set over the top of the ground support and press down on the top mating component to aid in sealing the side walls and the inlet face, and the inlet manifold can fit around the outside walls of the support structure and the top plate at the inlet face;

a downstream end of the first and second mating components extends freely in a cantilevered fashion out of the ground support, for example 10 or 20 cm of an 80 cm long component, so that the outlet splitters have space in the widthwise direction. The outlet splitter walls thus can have half a thickness of the ground support slot walls, which space the pairs of mating components apart, for example, 1 cm, in the widthwise direction;

filtered water can be collected simply via gravity by a perpendicularly running collection gutter that can be sloped. However the outlet splitter could have closed pipes for both the waste and filtered water;

the diffusiophoretic action can be easily reversed, for example by having the CO2 delivered to the top of the mating components and the top components sealed for example via a top plate, and the bottom components spaced from the bottom of the ground support for example by spacers so they are open to atmosphere. The filtered water of filtered for negatively charged colloidal particles for example can be run through a companion or the same device to filter positively charged particles if desired, and visa-versa;

vertical scalability can be provided with easily in a single ground support with spacers in higher slots, or with stacked ground supports, and either pump driven pressure for the inlet or an inlet manifold with stepped reservoirs, so that pressure for each row is the same;

slots and pins in the ground support and membrane supports can aid positioning, especially in the longitudinal direction, and still provide some vertical play.

The present invention also provides a diffusiophoretic membrane support having a longitudinally-extending first hollow interior. The present invention also provides a plastic supported diffusiophoretic water filter. The present invention also provides a modular diffusiophoretic water filter having first and second mating components defining a water channel. The present invention also provides a slotted ground support for a diffusiophoretic water filter. The present invention also provides a removable mating outlet splitter. The present invention also provides a perpendicular running collection gutter running perpendicular to a plurality of diffusiophoretic water channels. The present invention provides a diffusiophoretic water filter with a sealed front face, sealed except for the diffusiophoretic water channels. The present invention provides an inlet manifold covering a front face of a diffusiophoretic water filer having a plurality of channels extending downstream from the face. The present invention also provides a method for modularly assembly of a diffusiophoretic water filter. The present invention proved a method for repairing a diffusiophoretic water filter by replacing a modular component of the water filter. Other inventions are contained herein and may be broader than the concepts listed above.

A PDMS block can for example be made of silicone rubber blocks or sheets available from for example Rubber-Cal Inc. in St. Ana, Calif.

### BRIEF DESCRIPTION OF THE DRAWINGS

Some preferred embodiments are disclosed below:

FIG. 1 shows a schematic cross-sectional lengthwise view of a first embodiment;

FIG. 2 shows a schematic view through A-A of FIG. 1,

FIG. 3 shows a schematic cross sectional widthwise view within compressing device 270, which is not shown on FIG. 3;

FIG. 4 shows a widthwise schematic cross sectional view of modular components of the present invention held in a ground support;

FIG. 5 shows a lengthwise view of the embodiment of FIG. 4;

FIG. 6 shows an outlet splitter for connecting to an outlet end of a component;

FIG. 7 shows schematically the sealed inlet end of the FIG. 5 embodiment;

FIG. 8 shows an outlet end of the FIG. 5 embodiment;

FIG. 9 shows a membrane support schematically;

FIGS. 10 and 11 show further embodiments of the membrane support;

FIGS. 12 and 13 show a separate membrane cross support for sitting on the membrane support of FIG. 9;

FIGS. 14 and 15 show a second embodiment of an outlet splitter;

FIGS. 16, 17, 18, 19 and 20 show schematically a vertically and horizontally stacked embodiment; and

FIGS. 21, 22, 23, 24, 25, 26, and 27 are used to illustrate a manufacturing method for the above embodiments and/or further embodiments of the present invention; and

FIG. 28 shows membranes 24, 26 with an air release and CO2 channels (shown schematically much larger than actual for clarity) opposite the colloid channels on an opposite surface of the membranes.

Additional FIGS. 29 to 35 show further embodiments.

FIGS. 36 to 46 show a further embodiment of a DWF with an intergral outlet splitter and a method for manufacturing a DWF.

FIGS. 47 to 54 show yet further embodiments of a DWF in which

FIG. 47 shows diffusiophoretic water filter of an embodiment;

FIG. 48 shows a diffusiophoretic water filter of a further embodiment;

FIGS. 49 and 50 show schematically an outlet of the FIG. 47 embodiment;

FIG. 51 shows schematically an inlet of the FIG. 48 embodiment; and FIG. 52 an outlet of the FIG. 48 embodiment;

FIG. 52 shows an embodiment of a removable outlet structure; and

FIG. 53 shows a three outlet removable outlet structure of another embodiment.

### DETAILED DESCRIPTION

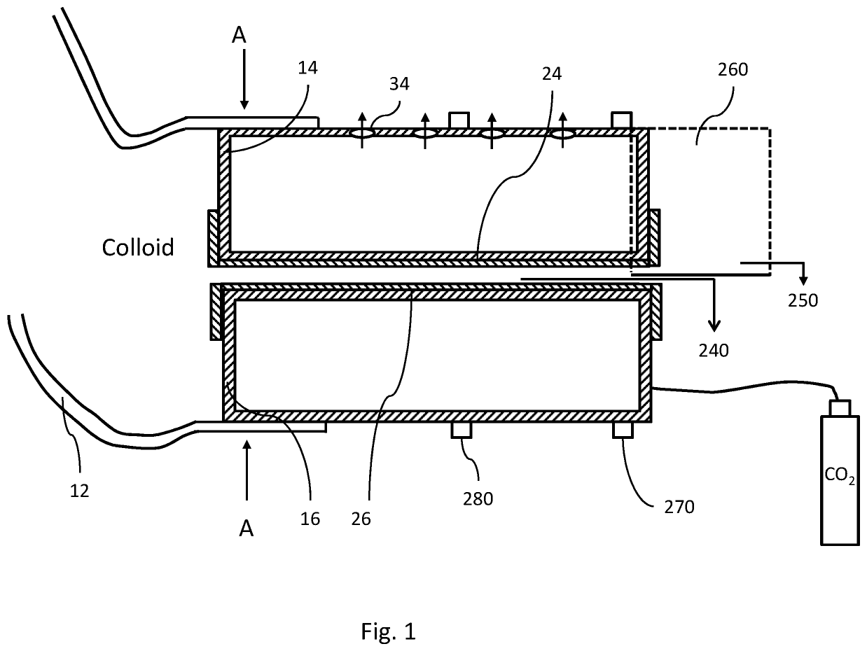

FIG. 1 shows a schematic cross-sectional lengthwise view of a first embodiment of a diffusiophoretic water filter of the present invention. Water flows from an inlet manifold with a heat shrunk supply tube 12 connected to the water filter at an inlet end of the water filter. The other end of the supply tube can be connected to a pressure regulator for example a height tube or pump for providing a colloid to be filtered. Two gas-permeable membranes 24, 26, for example PDMS 30 micrometers thick or thicker, define a channel, and are supported respectively on membrane supports 14, 16. Holes 34 can be used in this embodiment to allow gas to escape to atmosphere. Rubber bands 270, 280 or other compressive devices can press side walls of the membranes 24, 26 (or tapes on the membranes) together to help seal the sides of the colloidal channels. An outlet splitter 260 can fit over the end of one of the supports and be held between the side walls, and split the stream into a filtered water stream 240 and waste water stream 250 for example.

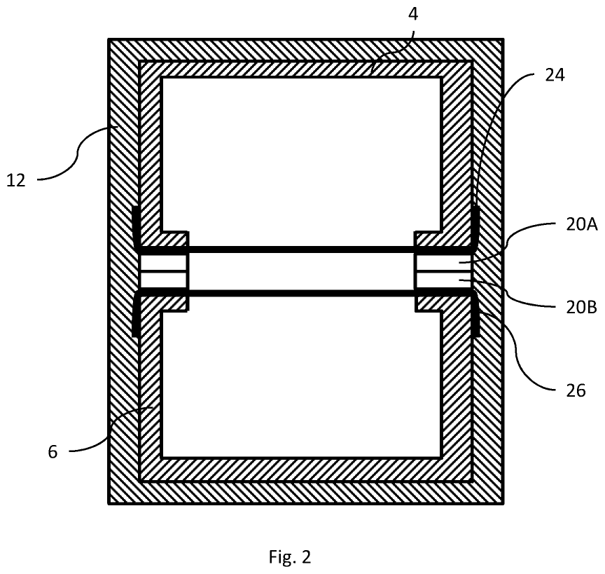

FIG. 2 shows a schematic view through A-A of FIG. 1, with tapes 20A, 20B defining side walls of the colloidal channel. Membrane 24, membrane support 14 and tapes 20A thus define a mating component 4 and membrane 26, membrane support 16 and tapes 20B a mating components 6.

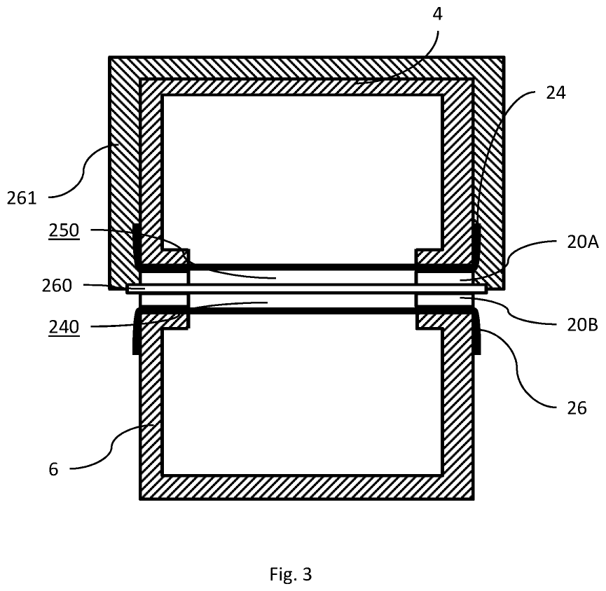

FIG. 3 shows a schematic cross sectional widthwise view at the end with compressive device 270, which is not shown on FIG. 3. Outlet splitter 260 has a splitter support 261 that fits over the end of component 4 and supports a blade or thin section, for example 30 micrometers thick or thicker that fits over the tapes 20A and between tapes 20A and 20B. The channels thus can be split into waste water stream 250 and filtered water stream 240, although the waste water and filtered water streams can be switched depending on the type of particles (negative or positive) being filtered or by switching the components so that component 4 delivers gas and component 6 is open to atmosphere. Tapes 20A and 20b thus set a clean a water/waste water splitting ratio and can be the same thickness for a 50/50 split or different thicknesses.

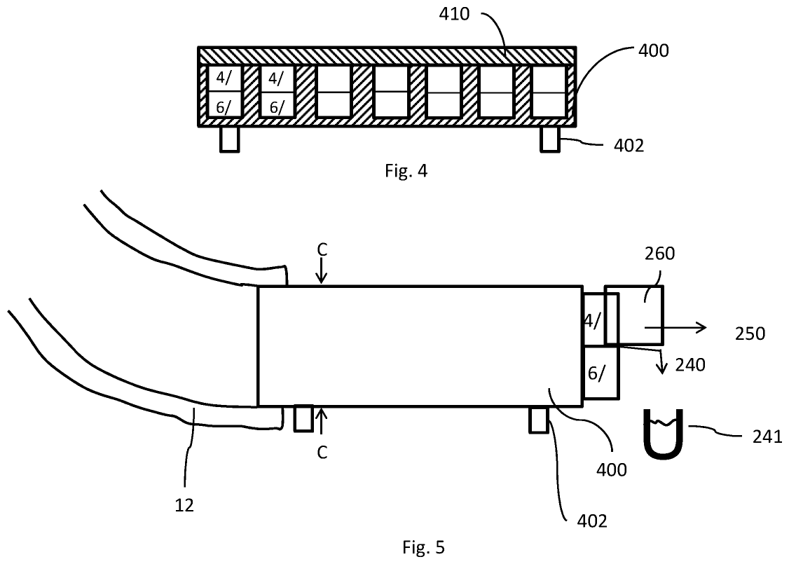

FIG. 4 shows a widthwise schematic cross sectional view of modular components of the present invention held in a ground support 400 with legs 402, and a top 410 (that can have openings or a grate that permits access to atmosphere for holes or slots in component 4). Top 410 can be a weight that presses down on component 4.

FIG. 5 shows a lengthwise view of the embodiment of FIG. 4, with clean filtered water collected from streams 240 over the width shown in FIG. 4 in a perpendicularly extending sloped gutter 241, which can collect the water. The ends or bottoms of the outlet splitter 260 can collect waste water for example in a connected tube so the waste water can be further processed or disposed of.

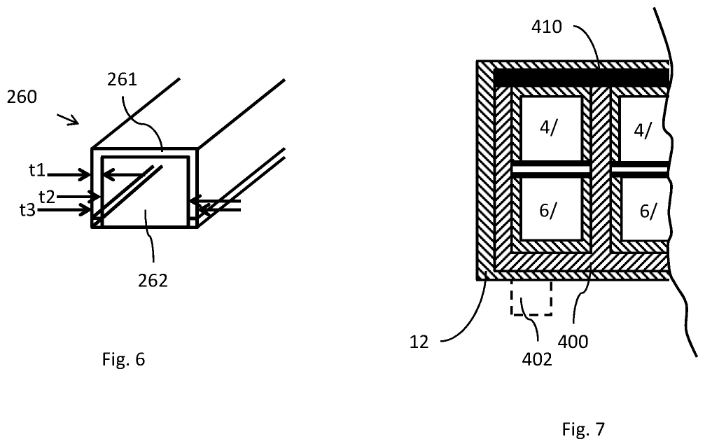

FIG. 6 shows an outlet splitter 260 for connecting to an outlet end of a component 6, and can have a steel blade 262 held by tapes to the ends of a U-shaped wall t1 thick of splitter support 261. Inner distance t1 can match the outer support 14 width, and t3 an inner width of slots of ground support 400;

FIG. 7 shows schematically the sealed inlet end of the FIG. 5 embodiment, with inlet manifold 12 surrounding the ground support front end, and thus a sealed face is presented with only openings for the channels.

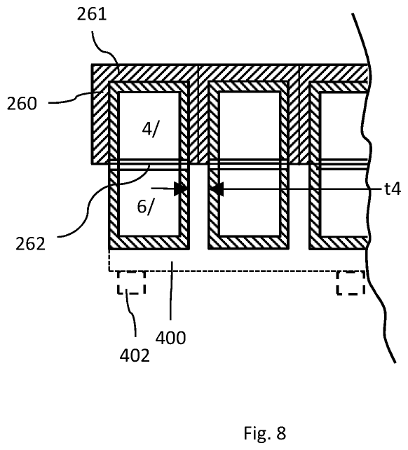

FIG. 8 shows an outlet end of the FIG. 5 embodiment showing how the splitter supports have space on the cantilevered ends of the support 14. The distance t4 can be twice t1.

FIG. 9 shows a membrane support 16 schematically but without the holes shown in FIG. 1 and instead having a slot 600. Membrane support 16 has a closed inlet end, a hollow interior, slot 606 on one longitudinally extending side and an open side opposite the side with slot 606 (the open top) for supporting membrane 26. A downstream end can have a hole for a connection for a CO2 supply tube 608. Slot 606 is sealed when support 16 is used as gas supply support, and open and not connected to a gas supply tube so that the support can function as support 14 supporting membrane 24 so that the support is open to atmosphere via slot 606 (and the hole for the CO2 connection). The hole also used for example to create vacuum pressure via a vacuum tube connection to aid in diffusiophoretic action.

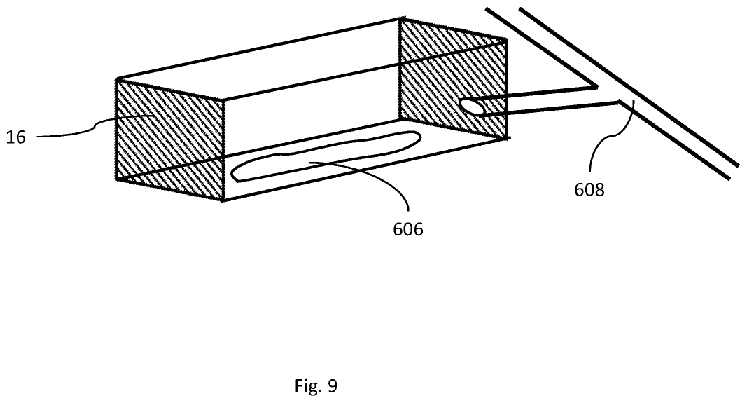

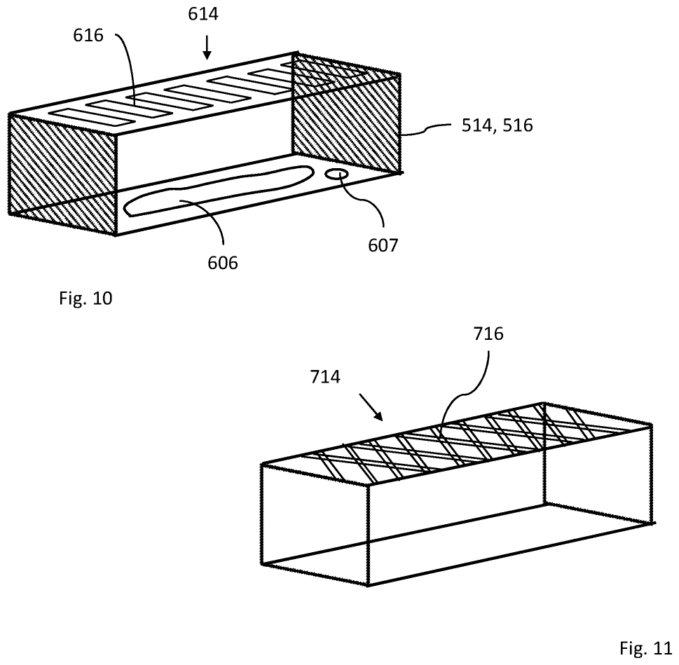

FIG. 10 shows with the open side 614 of a further embodiment of a membrane support 514, 516 having cross supports 616 for further supporting membrane 26. These cross supports may be made of PVC or other plastic and be part of the molded PVC part. FIG. 11 shows open side 714 with a cross hatching pattern of cross supports 716. The cross supports can keep the membrane 24, 26 from sagging or bulging and aid in placement and/or adhesion. The cross supports should be rather narrow, for example 1 mm or less to not interfere too much with CO2 or other gas diffusion. Honeycomb or other structures for the cross supports are also possible. Both slot 606 and hole 607 for a gas inlet are on a side opposite the open side as shown in FIG. 10 and as possible with the FIG. 11 embodiment. Hole 607 is in a cantilevered section of support 514, 516 out of a ground support so that a gas pipe can be attached. It also is far enough away from the outlet end that a splitter as in FIG. 14 does not cover the hole 607.

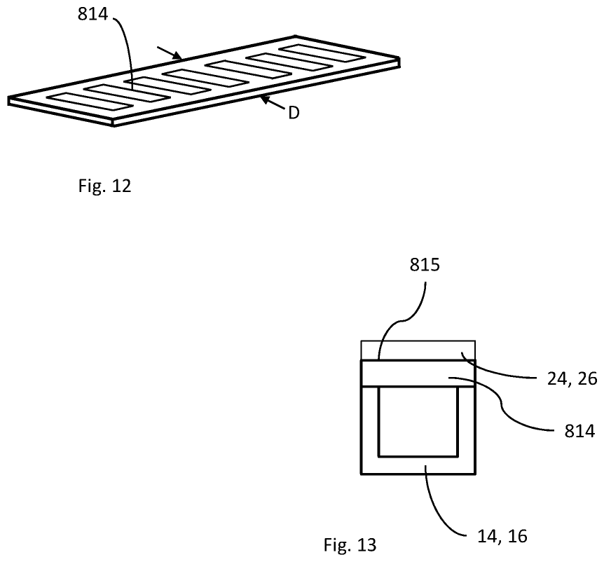

FIG. 12 shows schematically a separate membrane grated support, such as a cross support, 814 that can be adhered to a flat unstructured side 815 of membrane 24, 26, as shown in FIG. 13. Cross support 814 can be made of PVC, and can have side and end walls that match a thickness of the walls of membrane support 14 and 16 so that the cross support can be placed on the open side with the membrane.

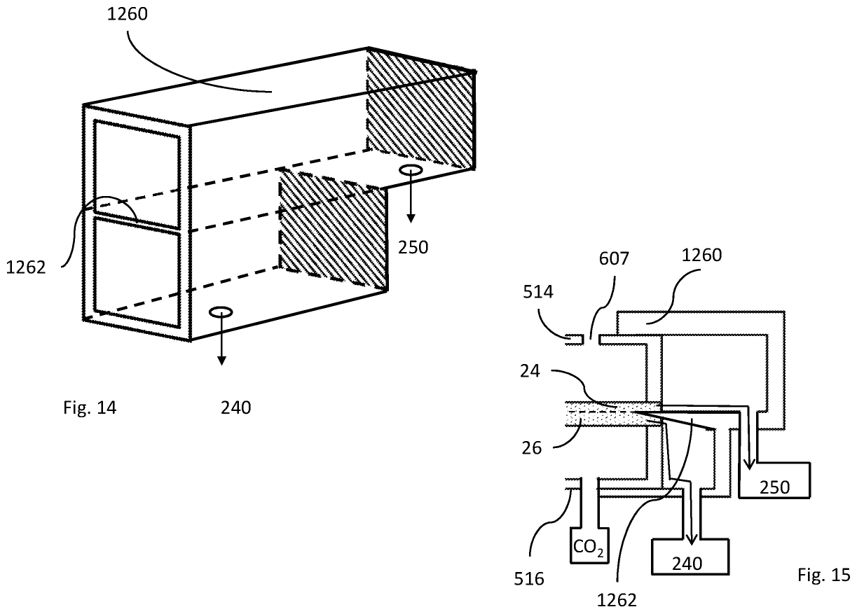

FIG. 14 shows an outlet splitter 1260 that fits over both ends of membrane supports 514, 516 as shown in FIG. 15. In this way both waste water 250 and filtered water 240 can be collected via a closed structure and piping connected to holes in the outlet splitter 1260, as shown. Splitter blade 1262 can be made of PVC and narrow to a point of 10 micrometers for example and fit between membranes 24, 26 as shown.

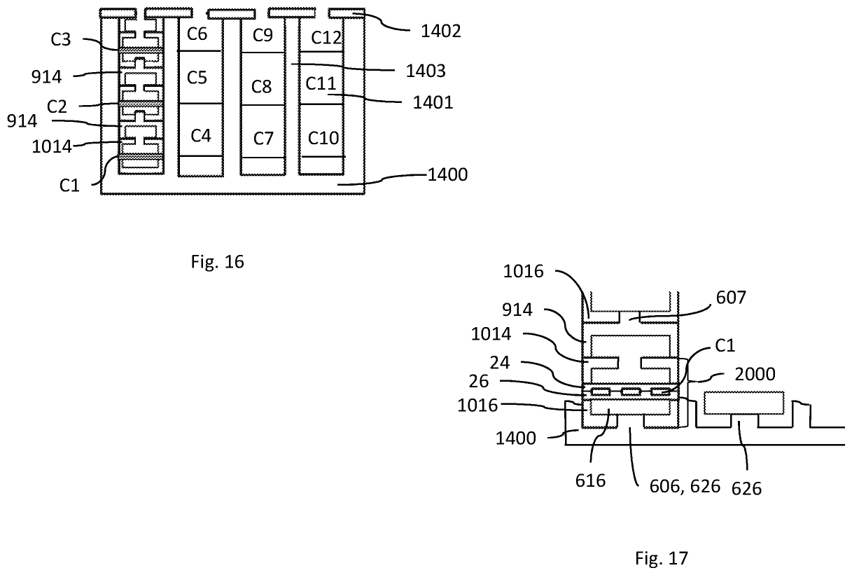

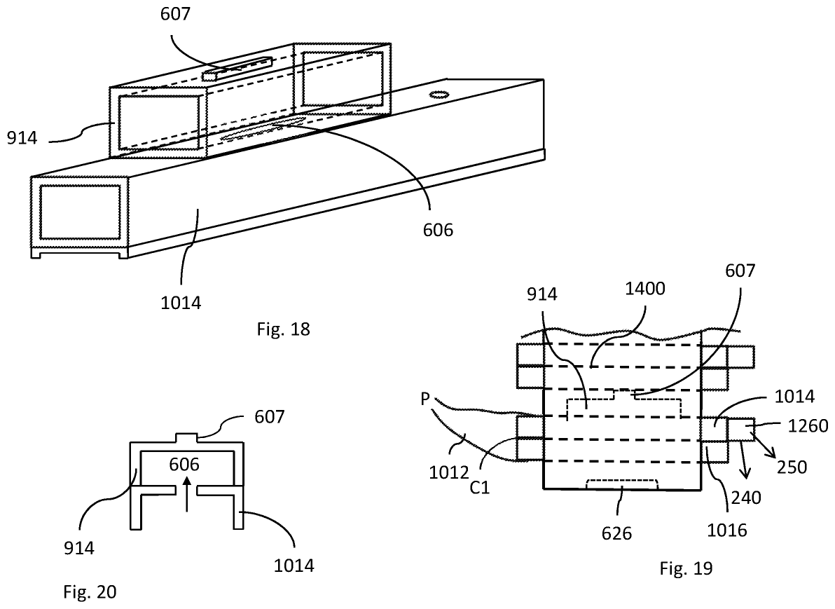

FIG. 16 shows in cross section a ground support 1400 with four slots 1401 defined by support walls 1403. In this embodiment and as shown in FIG. 17 as well, mated pairs of membranes 24, 26 on supports 1014, 1016 respectively define a module 2000 with a channel or set of channels C1. Three sets of channel(s) also can extend vertically and four widthwise so that sets of channels C1 to C12 are possible, although hundreds in each direction are possible. Since each channel set may have hundreds of channels, thousands or tens of thousands of channels or more may be present.

Membrane supports 1014, 1016 can be similar to supports 514, 516 in FIG. 10, but are lower in height, for example with an interior height of 1 cm, so a total height with a 50 mm wall is 1.5 cm, and the width still 2.5 cm. An interior height of 0.5 cm is also possible, for 1 cm high supports. A spacer 914 can fit between modules 2000 and be of a length similar to the walls 1403, for example 60 cm. Spacer 914 can be open at both ends and be U-shape as shown in FIG. 20 and have a height of 1 cm as well. Spacer 914 permits the space above membrane 24 to be open to atmosphere via slot 606 and both an open front and downstream side of spacer 914 as shown in FIG. 19. Spacer 914 can also be clipped to walls 1402 on both ends to position spacer 914 longitudinally with respect to base 1400. Spacer 914 then has a protrusion 607, integral and made of PVC or plastic for example, that can seal slot 606 in membrane support 1016, which delivers CO2 to membrane 26. Protrusion 607 can be coated with an elastomer to aid sealing and also positions the membrane support 1016 longitudinally. Ground support 1400 at the bottom of each slot also has a protrusion 626 that can seal and longitudinally position first membrane support 1016, which also delivers gas.

FIG. 19 shows how the membrane supports 1014, 1016, which can be 80 cm in length, cantilever out the front and rear of ground support 1400. Water can be supplied to each channel C1 through C12 by individual water manifolds 1012 connected to a settable pump P that can set a common inlet colloid (water) pressure, for example 30 mbar. Waste water 250 can be collected on each row as can filtered water 240, and the water conveyed further via suction or gravity.

A top 1402 (FIG. 16) can supply a defined pressure to the stacks of modules in each slot to aid in sealing of the membranes 24, 26 at the side walls of the membranes.

A ground support 1400 can hold for example 50 modules vertically for a height around 1.5 meters, and have 2 cm thick walls so that 40 slots and modules horizontally is about 1.8 meters in width. With three channels per channel set C1 of 250 micrometers (125 micrometer half channels) and a width of 0.3 cm, at a pressure of 30 mbar flow is estimated as laminar with a Reynolds number of 11.8 and a velocity of 0.0256 m/s and a flow rate of 1.15 ml/min. A dwell time in the 80 cm long channel is 39 seconds giving time for many particles to move 200 micrometers via diffusiophoretic motion. A 50/50 split at 125 micrometers thus given a good filtering effect on the 250 micrometer wide stream, and clean water flow of 0.575 ml/min. With 200 channels sets and 600 channels, the device can produce 345 ml/min of clean water or 20.7 liters per hour. Higher throughputs with higher pressures are also possible and larger channel sizes are also possible.

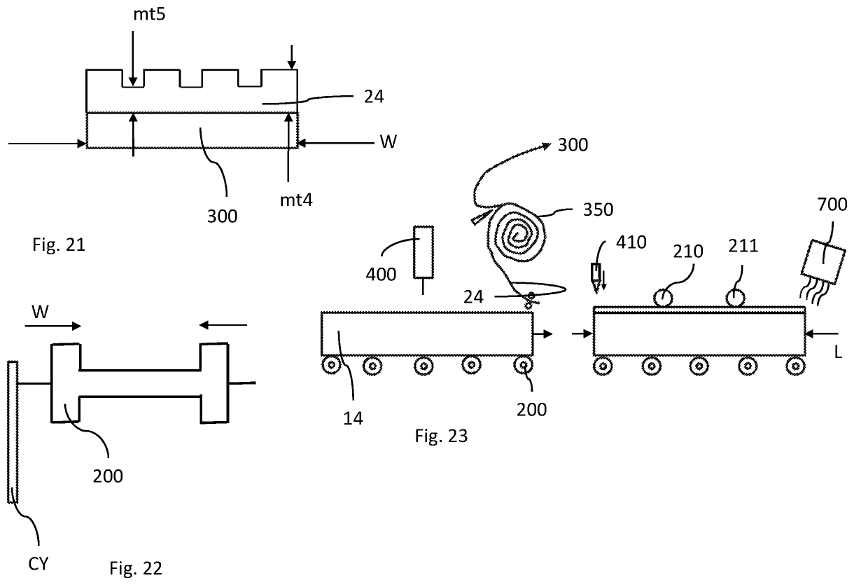

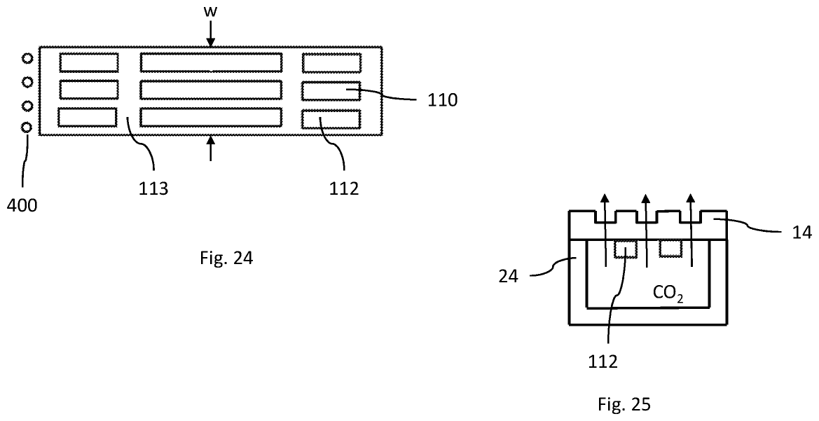

FIG. 21 shows a possible channel structure for a membrane 24 backed on a tape 300. The membrane can be for example 250 micrometer thick at mt4 and have 125 micrometer deep channels as shown at mt4 that are 0.3 cm wide (schematically shown). A base thickness mt5 of 125 micrometers which can allow CO2 flow remains, although thinner base thicknesses are possible for better CO2 diffusion. Side walls of 0.5 cm width can be provided. A width W can be 2.5 cm and match a width of w as shown in FIG. 24, which shows transversely spaced adhesive applicators 400. The membrane 24 can be easily manufactured using a 250 micrometer thick PDMS continuous ribbon with the channels cut by CO2 lasers, which is an easy and inexpensive method, although milling, grinding and other possibilities exist. The tape backed ribbon can be rolled from a roll 350 as shown in FIG. 23. An adhesive applicator 400, which may have a brush or widthwise applicators, can apply an adhesive such as a silicone-based adhesive to membrane support 14 as shown in FIGS. 23 and 24, and thus adhesive applied to longitudinal supports 112 between gas or air holes 110. The adhesive can also be applied to cross supports 113, which are optional, if present. The amount and thickness of the adhesive is relatively unimportant, but the gas or air 112 holes should remain clear.

FIG. 22 shows rollers 200 moved by a conveyor CY used to move supports 14 through a manufacturing process. As shown in FIG. 23, the adhesive is applied by applicator 400, and the membrane 24 unrolled and the tape 300 removed. A cutter pair 410 (not showing a second cutter downstream near the nip of the tape roller) can operate near the nip of the tape rollers and cut section of the membrane widthwise. Pressing rollers 210, 211 can press the membrane against the support 24 for a good adhesion. FIG. 23 shows as well a CO2 laser array 700, transverse to the direction of movement, that can cut the channels into the PDMS membrane after adhesion, which may be preferable. In this case the roll 350 is simply of a sheet for example made of PDMS 250 micrometers thick. FIG. 25 shows the attached membrane 24 on longitudinal supports 112 and side walls of support 24 at a cross sectional location. The membrane 24 and support 24 can be for a length L, for example 80 cm long.

Length L, width W and all the other dimensions can be application and material specific. It may be for example that widths of 15 or 30 cm for the membrane supports 24, 26 and membranes 14, 16 are preferred, and many more channels provided widthwise. This can reduce the number of CO2 and colloid input connections and base support slot material, as well as providing more channels per unit width.

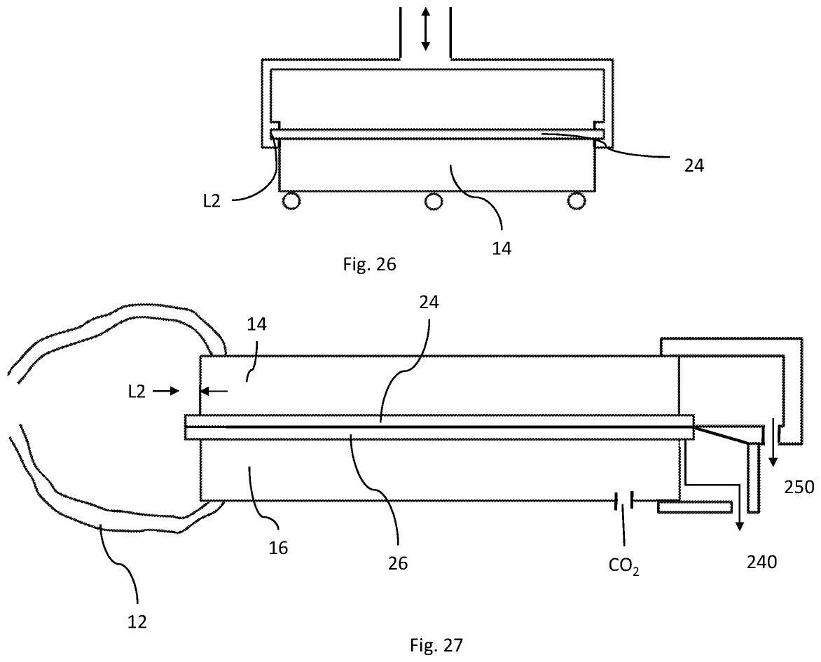

An oversized length of the membranes 24, 26 and precision of placement in the lengthwise direction advantageously has little impact on the functioning of the filter, and in fact extra length L2 can be used to stretch and place precut membranes 24, 26 on their respective supports as shown in FIG. 26 with a vertically moving applicator. As shown in FIG. 27 the inlet and outlet splitter functions remain unimpeded.

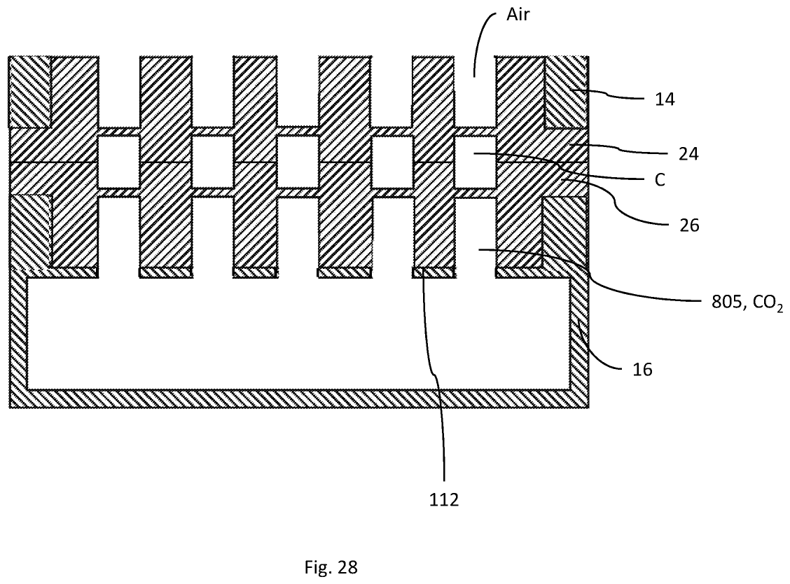

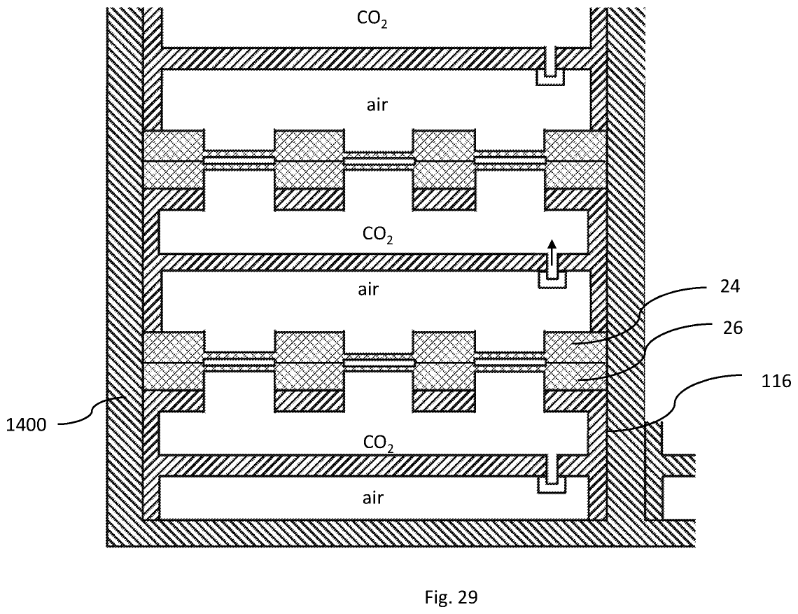

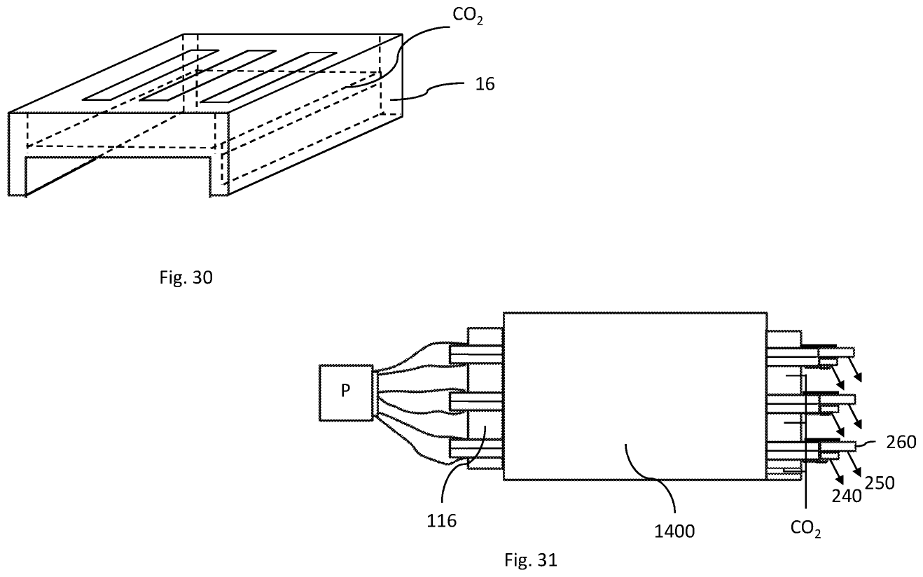

The thicknesses and channel sizes of the membranes 14, 16 also may be varied, particularly it may be desirable to have a thicker PDMS base with CO2 channels 805 cut into the side opposite the colloid channels C between PDMS material support on longitudinal supports 112, as shown in FIG. 28. These CO2 channels 805 can be directly opposite the colloid channels, and be the same or deeper, but need to be sealed at the ends either by the way they are imparted into the PDMS material, or by front and rear extensions of the supports 24, 26, and or by adhesive or other material closing the CO2 channel ends.

FIGS. 29 and 31 show a possible stacking of the FIG. 28 embodiment in a support 1400. Integrated CO2 and air spacers 116, with a bottom open end air area with an end entry for a CO2 pipe and a closed end CO2 chamber can be provided as shown in FIG. 30. FIG. 32 shows the inlet area for channels C of the FIG. 31 embodiment, and FIG. 33 an outlet area.

FIGS. 34 and 35 show an alternate engagement of the membrane 26 with a spacer or a CO2 chamber 816 where pegs 817 sit over slots 818 and fit in and support the membrane 26 between rigs at CO2 channels 805 (or air channels for a membrane 24)

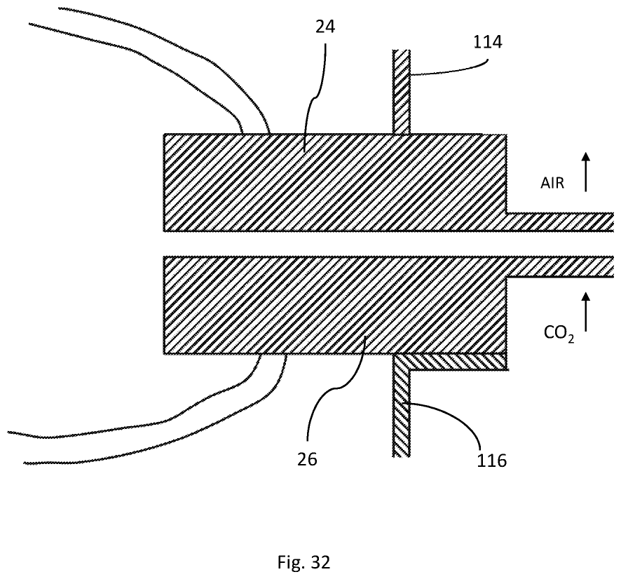

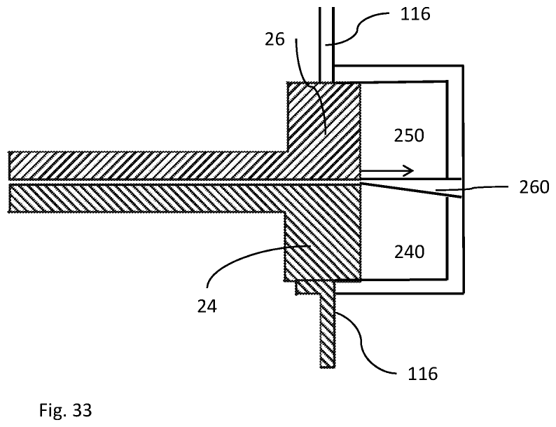

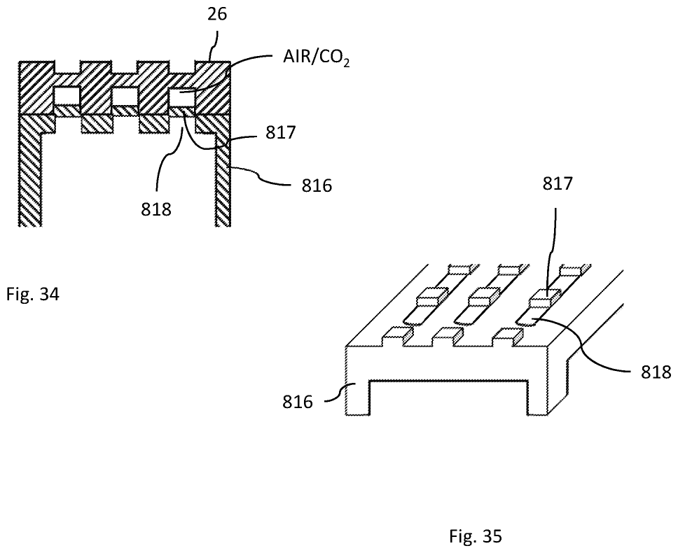

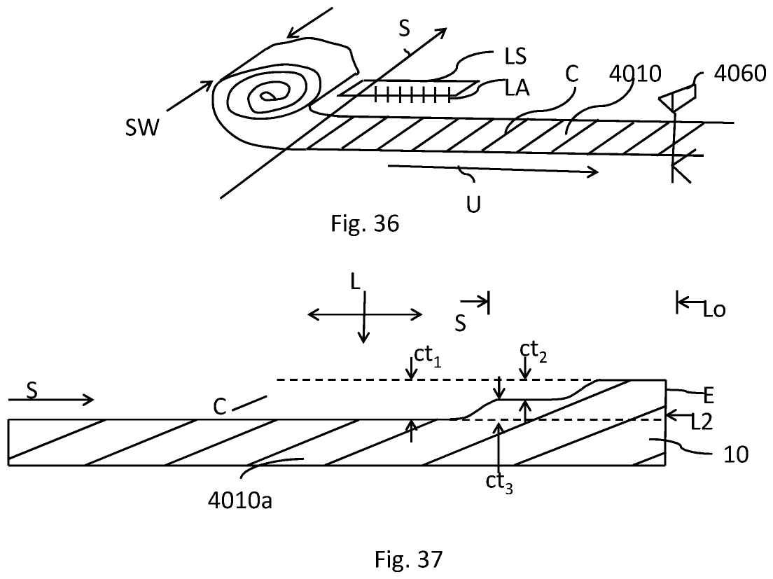

FIGS. 36, 37 and 38 show a sheet 4010 of PDMS material that can for example be a 1 mm thick sheet and 80 cm wide at sheet width SW. A laser support LS with a plurality, for example 100, lasers LA, for example CO2 lasers spaced 1 mm apart in the unwinding direction U can move on a structure crosswise to the sheet 4010, which can stop after being unwound for example 1 m in direction U. The lasers then move crosswise in direction S and machine channels C, for example 100 channels C at a first power, and are focused and powered to cut the channels 200 micrometers deep at ct1, and at width W of for example 500 micrometers (250 micrometers on either side of each laser LA). The channels thus can be spaced 500 micrometers apart, and cover 50% of the 1 meter length on the sheet in direction U. After most of the channels C have been cut in direction S, the power can be reduced so that only a depth ct2 is machined, for example at 100 micrometers. A width w can remain the same. A second set of lasers behind or in front of lasers LA could also be used to machine the ct2 depth. Before the edge E, the laser machining can stop so no material is machined.

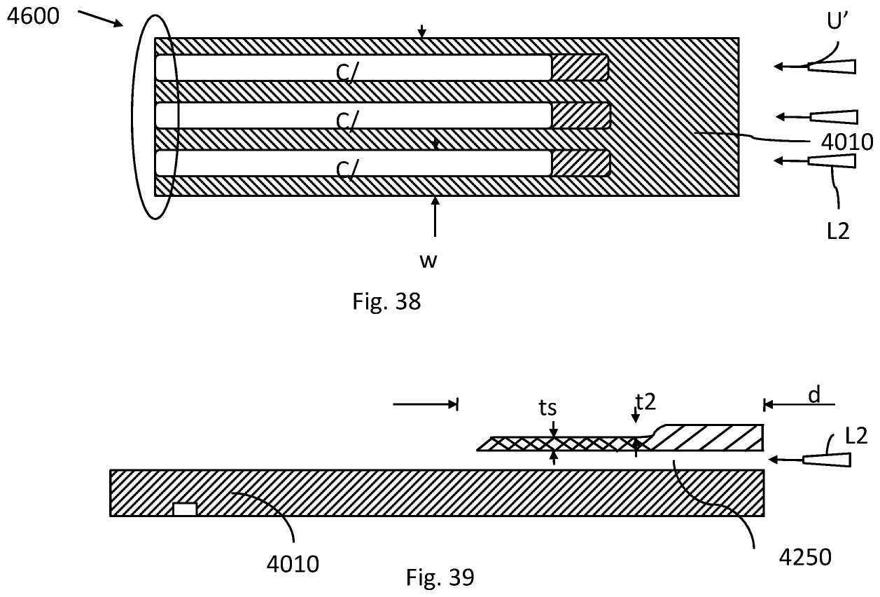

As shown in FIGS. 38, 39 and 40, a second laser or set of lasers L2 can machine in a direction U′ through the thickness ct3 to provide a channel outlet 4250, for example for waste water. The channel 4250 can have a depth for example of 90 micrometers and width of 500 micrometers and a length of Lo that can preferably be 1 cm or more. A high precision laser such as a YAG laser thus is desired, and one of more precision than the lasers used for channels C, which can be inexpensive CO2 lasers for example. A splitter 4270 of 10 micrometer thickness is thus can remain, although other sizes are possible.

The sheet 4010 can be unwound another meter and processed again so that a continuous sheet of perpendicularly extending channels, for example 100 meters long can be produced. A cutter C can cut the sheet to any desired location in direction U, which can then define the width of water filter, with SW generally defining the length.

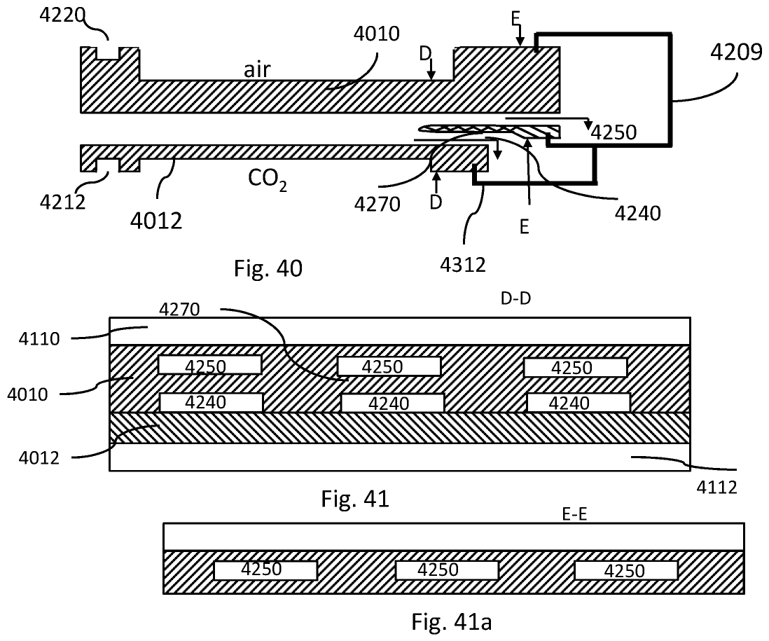

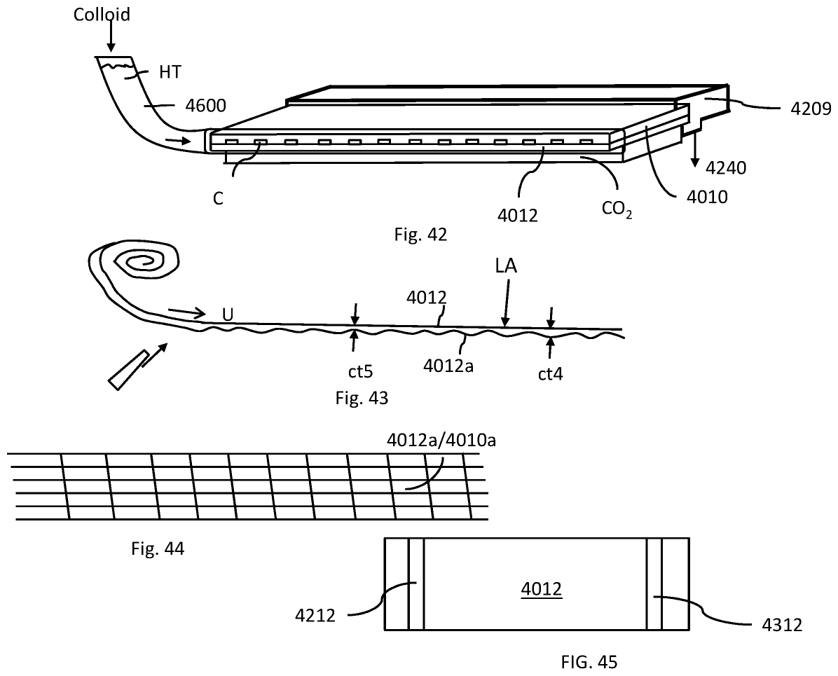

As shown in FIGS. 40, 41 and 41a, and 42 the sheet 4010 thus produced can be placed on a water impermeable, gas permeable sheet 4012, with for example an air or gas permeable support 4110, 4112 for each. Air channels on the side opposite the water channels C can also be machined into sheet 4010 and gas channels into the side of sheet 4012. An outlet 4209 with one or more perpendicularly running collection channels can collect the waste water 4250 and the filtered water 4240 and fit in a slot 4312 to seal the outlet to the sheets 4010, 4012 or a support. The outlet can thus also clamp the sheets 4010/4012 together. Likewise, slots 4212, 4220 can be provided for a perpendicularly running inlet manifold 4600 which can have a tube with a slot into which the inlets of the channels C fit and are sealed. A height of the manifold above the outlets in a height tube HT can set the pressure and thus flow rate for the channels C, and may be for example between 10 and 100 cm.

FIG. 43 shows how the side 4012a of the sheet 4012 and the water channels C can be structured with CO2 channels to thin the sheet of thickness ct4, for example 1 mm to thickness ct5, for example 50 micrometers, so that CO2 can permeate the sheet 4012 into channels C. As shown in FIG. 44, a cross wise pattern or any other pattern promoting CO2 diffusion can be machined or extruded into sheet 12. Grooves 4212, 4312 for the inlet manifold 600 and outlet 209 can also be machined in the unwind direction U as shown in FIG. 45

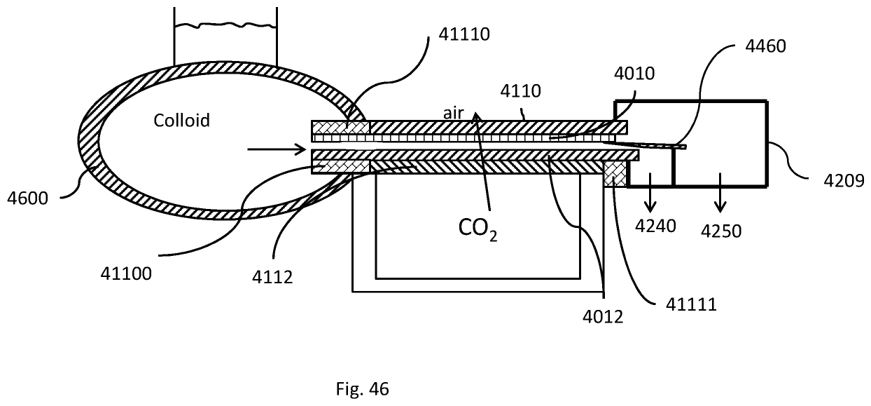

As similar manufacturing and construction can be used for sheets where the channels are simply cut all the way through to the second end by lasers LA (FIG. 36), and where a long removable splitter for example is used to fit between the two sheets at the outlet end. FIG. 46 shows the water filter with sheet 4012 on a support 4112 over a CO2 chamber. Support 4112 is gas permeable, for example a honeycomb structure, except at seal locations 41100 and 41111. Support 4110 for sheet 4010 is also air permeable except for a seal location 41110. In that case outlet 4209 can have a separate splitter 4460 as shown.

An easily manufactured and high output device thus can be provided, and can extend for example 100 meters or more in length easily.

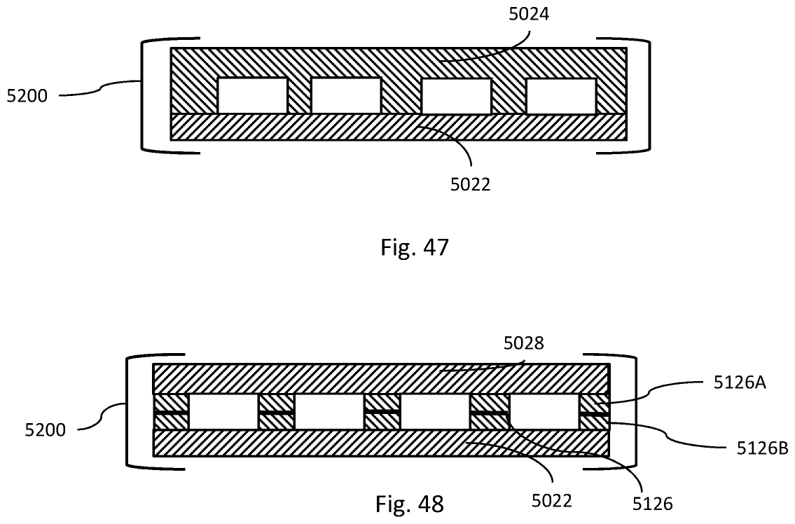

FIG. 47 shows a diffusiophoretic water filter with a diffusiophoretic-inducing membrane 5022 and a cover 5024, clamped together via clamps 5200 and defining a plurality of longitudinally-extending channels.

FIG. 48 shows a diffusiophoretic-inducing membrane 5022 and a cover 5028, clamped together via clamps 5200 and defining a plurality of longitudinally-extending channels. Membrane 5022 and cover 5028 are spaced apart by tapes 5126, each with two tapes 5126A, 5126B laid over each other.

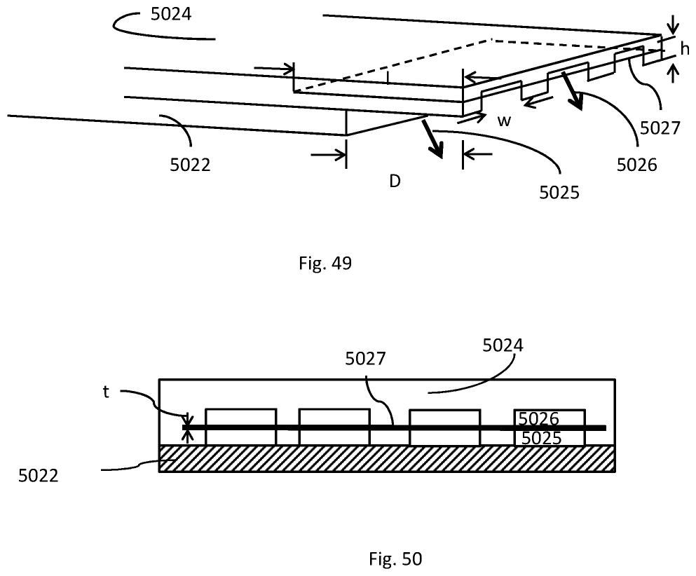

FIGS. 49 and 50 show schematically an outlet of the FIG. 47 embodiment. A stainless steel blade 5027, for example 2 cm in length l, cuts channels with a width w of for example 20 micrometers to 2 cm and height h of 50 to 1000 micrometers in half over length l. The blade 5027 may have a thickness t of 10 micrometers for example and define a waste outlet 5026 and a clean water outlet 5025. Blade 5027 advantageously can be slid into a soft material of the cover made of silicone (PDMS) for example. The method for manufacturing the outlet thus is easy, and also provides for easy manufacture of the channels in the PDMS material of cover 5028, for example by milling or laser cutting. Clean water outlet 5026 may be spaced a distance D, for example 1 cm, in the longitudinal direction so that water may exit by gravity. Waste water stream 5026 containing negatively-charged colloids pushed away from membrane 5022 exits further downstream and can be discarded for example.

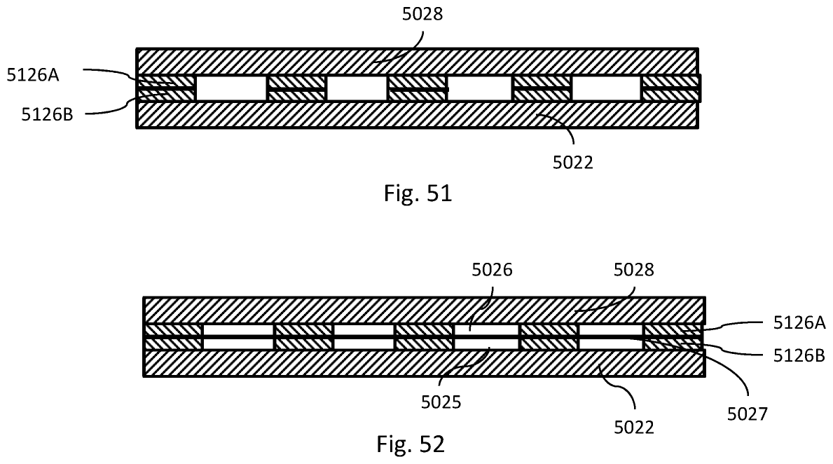

FIG. 51 shows schematically an inlet of the FIG. 48 embodiment; and FIG. 52 an outlet of the FIG. 48 embodiment, where the splitter 5027 is between tapes 5126A and 5126B. The tapes 5126A, 5126B can run the whole length of the filter, or can be slit into the two tapes just at the outlet. The splitter can be made of plastic or metal, and may be the same as in the FIG. 49 embodiment, although the tapes permit usage of many types of splitters. The tapes 5126A, 5126B can be for example 125 micrometer thick PTFE tapes or made of other materials.

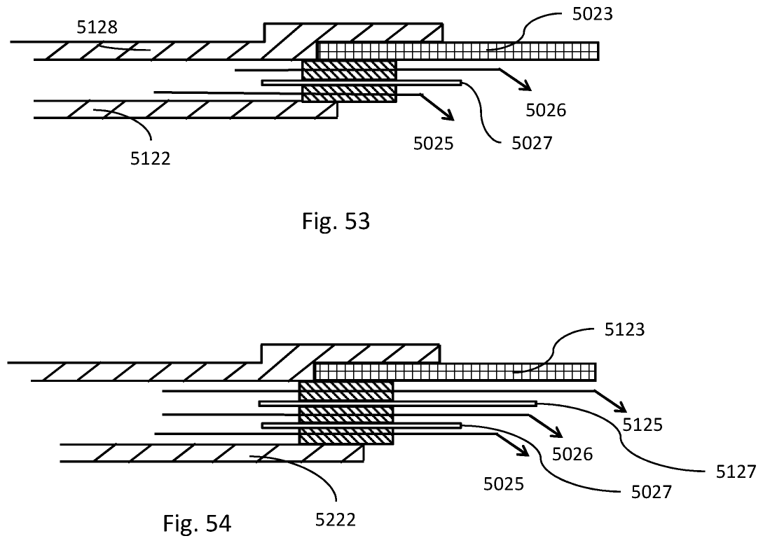

FIG. 53 shows a further embodiment of a removable outlet structure that fits between a diffusiophoretic-inducing membrane 5122 and a cover 5128 that may or may not have a channel structure. A support 5023, for example made of stainless steel 1 mm thick, can have tapes supporting a blade or sheet 5027. The membrane 5128 can hold the outlet structure in place against membrane 5122, or a separate clamp could be provided.

FIG. 54 shows a three outlet removable outlet structure of another embodiment in which three outlet streams 5025, 5026 and 5125 are provided by two splitters 5027, 5127 spaced apart by tapes and supported by a support 5123. Outlet stream 5125 can have negatively charged particles, outlet stream 5025 positively charged particles, and stream 5026 filtered water.

1-59. (canceled)

60. A gas-driven diffusiophoretic filter comprising:
a first membrane support having a longitudinally-extending first hollow interior;
a gas-permeable first membrane covering the first hollow interior;
a gas-permeable second membrane;
a second membrane support supporting the gas-permeable second membrane,
the first and second supports being positionable so that the first and second membrane define at least one diffusiophoretic water channel having an inlet end for accepting a colloid; and
an inlet manifold extending over the first and second membrane supports to seal the inlet.

61. The gas-driven diffusiophoretic filter as recited in claim 60 wherein the first membrane support has a closed inlet end, a hollow interior, and an open side supporting the first membrane.

62. The gas-driven diffusiophoretic filter as recited in claim 61 wherein the membrane support has a hole for a CO2 supply tube.

63. The gas-driven diffusiophoretic filter as recited in claim 61 wherein the open side has cross supports.

64. The gas-driven diffusiophoretic filter as recited in claim 61 wherein the first membrane support is a molded part.

65. The gas-driven diffusiophoretic filter as recited in claim 61 wherein the open side has cross supports.

66. The gas-driven diffusiophoretic filter as recited in claim 60 further comprising a splitter between first and second membranes.

67. The gas-driven diffusiophoretic filter as recited in claim 66 wherein the at least one diffusiophoretic water channel includes a plurality of diffusiophoretic water channels and the splitter extends across the plurality of diffusiophoretic water channels.

68. The gas-driven diffusiophoretic filter as recited in claim 66 wherein the splitter is made of metal.

69. The gas-driven diffusiophoretic filter as recited in claim 66 wherein the inlet manifold includes a plastic tube stretched over ends of the first and second membrane supports.
